(19) United States
(12) Patent Application Publication
(10) Pub. No.: US 2015/0164006 A1
(43) Pub. Date: Jun. 18, 2015

(54) Support Element and Guide for Vines

(71) Applicant: RIOJA VID TECNOLOGIA, S.L., La Rioja (ES)

(72) Inventor: Angel Ricardo Martin Alvarez, La Rioja (ES)

(21) Appl. No.: 14/566,968

(22) Filed: Dec. 11, 2014

(30) Foreign Application Priority Data
Dec. 12, 2013 (ES) 201331425

(51) Int. Cl. A01G 17/04

(52) U.S. Cl. CPC A01G 17/04

(57) ABSTRACT

The present invention relates to a support element and a guide for vines whose interaction with the harvester machine is minimized. Additionally, the support element and guide for vines according to the invention herein provides a more stable fastening for the hooks with the wire cables. The support element and guide is characterised in that the branches of the body have a convex shape so as not to protrude from the pole and, therefore, not to be dragged along by the harvester machine. Also, and preferably, the hook portions form a U with the second end of the corresponding hook section, enabling the cables to be retained more securely, thereby minimizing the risk of the cables becoming released from the hooks due to the vibrations caused by the harvester machine.

### CROSS REFERENCE TO RELATED APPLICATIONS

This application claims priority of ES Application No. 201331425 filed Dec. 12, 2013, which is incorporated herein in its entirety.

### OBJECT OF THE INVENTION

The invention herein can be included in the technical field of agriculture, more specifically, viticulture. In particular, the object of the invention relates to a support element and guide for vines.

### BACKGROUND OF THE INVENTION

Usually, the vineyards are arranged in straight rows, in each of which there are a number of grape plants arranged one after the other, maintaining a given distance.

To provide appropriate growth to the vine shoots, a plurality of poles being aligned to each other and with the corresponding row are arranged within each row and are generally arranged at different heights, depending on the height reached by the vines, two separate metal wires facing each other, one on each side of the poles, a space for growing between said cables defining each pair of facing wires in order to house the vine shoots.

Depending on the time of year, the vine shoots have to be confined inside the growing space or outside of said growing space.

Support elements are used to facilitate the confinement of the vine shoots within the area of growth and their release, as appropriate, which are attached to the poles, wherein each support element comprises a warped body and are usually made by folding, bending or curving a wire thread. Each body comprises two branches, each provided with a respective first end, in which the branches converge to form a V, and a second end.

The body further includes a torsion spring located at the apex of the V, configured to exert a recoil force on the branches which tends to separate the branches from each other, opening the V.

The body further comprises two spacing sections provided with: a respective first end right-angled at the second end of the corresponding branch; and a corresponding second end. A first spacing section, corresponding to a first branch protrudes frontally from the V plane, while a second spacing section, corresponding to a second branch protrudes from the V plane in the opposite direction to the first spacing section. The spacing sections, in general, are not perfectly straight, but have a slight bend to facilitate rolling of the cables in said spacing sections.

Also, the body includes two separate hook sections provided with: a respective first end right-angled at the second end of the corresponding spacing section; a respective second end provided with a shape comparable to an arrowhead, and an intermediate portion located between the first end and the second end.

The second end of each hook section comprises a hook portion, which defines an acute angle with the intermediate portion, forming a hook to engage or release the cable from the opposite end of the pole.

The spacing segments provide a separation between the hook sections to avoid interference between the actual hook sections, since the hook sections are spaced apart by a distance related to the length of the spacing sections.

Often the cables are released undesirably when the grape harvesters pass by, either because during harvesting said harvester machines accidentally drag the support elements, and also because the harvester machines cause vibrations in the cables that remove the cables from the hooks.

### DESCRIPTION OF THE INVENTION

The invention relates to a support element and a guide for vines whose interaction with the harvester machine is minimised.

Additionally, the support element and guide for vines according to the invention herein provides a more stable fastening for the hooks with the wire cables.

The support element and guide according to the invention herein is characterised by the fact that the branches of the body have a convex shape so as not to protrude from the pole and, therefore, not to be dragged along by the harvester machine.

Also, preferably, the hook portions form a U with the second end of the corresponding hook section, enabling the cables to be retained more securely, thereby minimizing the risk of the cables becoming released from the hooks due to the vibrations caused by the harvester machine.

### DESCRIPTION OF THE DRAWINGS

As a complement of the description being made and for a better understanding of the characteristics of the invention, according to an example of a practical preferred embodiment thereof, attached as an integral part of the aforementioned description is a set of drawings where, for purposes of illustration and in a non-limiting manner, the following is shown:

FIG. 1 shows a front-bottom perspective view of the support element and guide for vines according to the invention herein.

FIG. 2 shows a side view of the support element and guide in FIG. 1.

### PREFERRED EMBODIMENT OF THE INVENTION

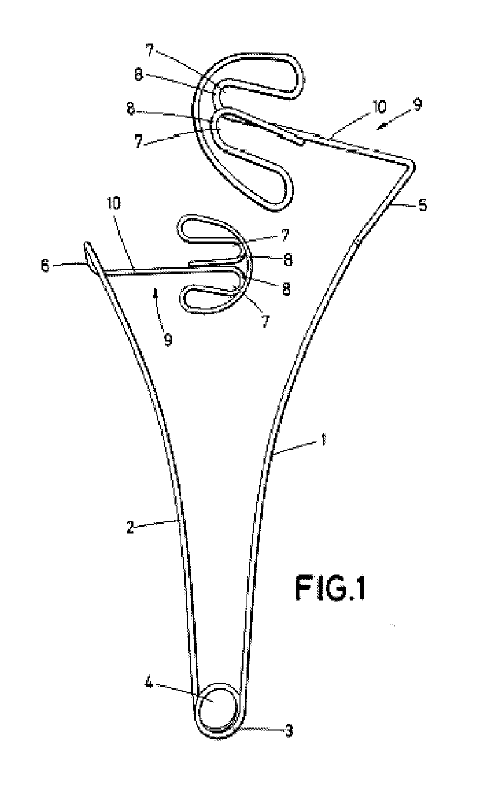

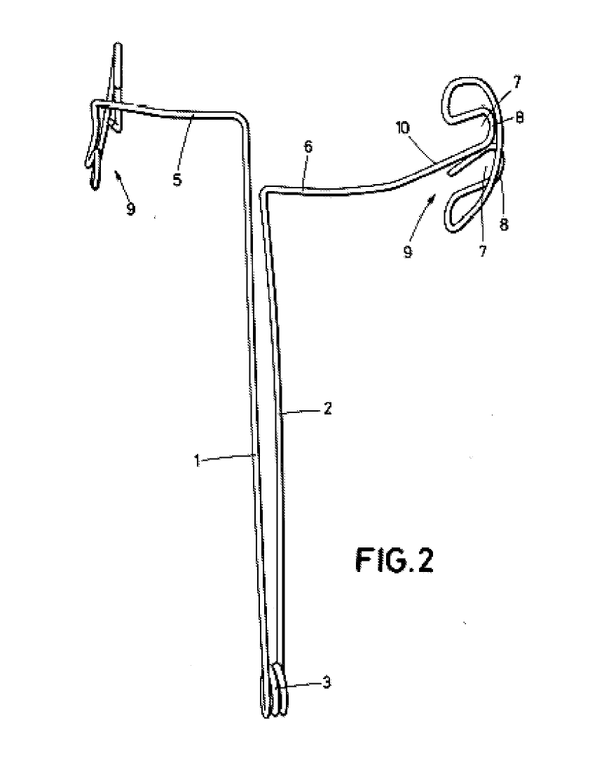

Described hereinbelow, with reference to FIGS. 1 and 2 referred to above, is a detailed description of a preferred embodiment of the invention.

As seen in FIGS. 1 and 2, the support element and guide for vines according to the invention herein comprises a warped body made of formed wire thread; in particular, formed by rolling, folding, curving, bending or similar operations. The body comprises two branches (1, 2) which include:
a first end, wherein the branches (1,2) converge defining a V; and
a second end.

The V further comprises an apex wherein there is a torsion spring (3), configured to exert a recoil force on each branch (1, 2) which tends to separate the branches (1, 2) opening the V. The spring (3) has a hole (4). Refer to FIG. 1, preferably a central hole (4), configured to fix the body to a pole (not shown) , which is arranged along a row of vines, wherein a metal wire (not shown) is attached to each side of the pole. For example, the body can be secured to the pole by nailing the body to the pole by means a screw (not shown) inserted into the hole (4), or by inserting the ends of a clamp or a clamp assembly (not shown)into the hole (4).

The invention is characterised by the fact that, as seen in FIG. 1, the branches (1, 2) have a concave shape, namely, bending towards the inside of the V. The branches (1, 2) are preferably curved in shape, as shown in FIG. 1, although it is also possible that each of the branches (1, 2) has a plurality of straight sections (not shown) that define branches (1, 2) in a concave shape.

The body further includes two separate spacing sections (5, 6), each of which comprises:
a first end right-angled on the second end of the corresponding branch (1, 2); and
a second end;

wherein a first spacing section (5), corresponding to a first branch (1) protrudes frontally from the V, while a second spacing section (6), corresponding to a second branch (2) protrudes from the V in the opposite direction to the first spacing section (5), namely, to behind the V.

The body also comprises two separate hook sections (9), equipped with:
a first end, right-angled with the second end of the corresponding spacing section (5, 6);
a second end, comparable to an arrowhead, which is represented as rounded in the figures; and
an intermediate portion (10) located between the first end and the second end.

The second end of each hook section (9) comprises a hook portion, characterised by the fact that it defines a U-shape (8) with the corresponding intermediate portion (10), forming a hook (7) to engage or release the cable at the opposite end of the pole, which when in the locked position, the cable is retained more securely by the hook (7), minimising the risk of the cables being released from the hooks (7) due to the vibrations caused by the harvester machine.

The spacing sections (5, 6) maintain the hook sections (9) separated from each other and, therefore, they also keep the hooks (7) separated from each other, by a distance defined by the length of the spacing sections (5, 6) to avoid interference between the hooks (7).

1. Support element and guide for vines, comprising a warped body made of formed wire thread:
two branches (1, 2) each of which comprises:
a first end, wherein the branches converge defining a V provided with an apex; and—a second end;
a torsion spring, located at the apex of the V, configured to exert a recoil force on each branch which tends to separate the branches opening the V;
two separate spacing sections, each of which comprises:
a first end right-angled on the second end of the corresponding branch; and
a second end, wherein a first spacing section
corresponding to a first branch protrudes from the V at the front, while a second spacing section, corresponding to a second branch, protrudes from the V in the opposite direction to the first spacing section; and
two separate hooks located on the corresponding free end of the spacing sections and separated by a distance related to the length of the distance sections;
wherein the branches have a concave shape towards the inside of the V.

2. Support element and guide for vines according to claim 1, wherein the branches have a curved shape.

3. Support element and guide for vines according to claim 1, wherein the body comprises two separate hook sections, comprising in turn:
a first end, right-angled with the second end of the corresponding spacing section;
a second end, comparable to an arrowhead; and
an intermediate portion located between the first end and the second end;
wherein the second end of each hook section comprises a hook portion, which defines a U shape with the corresponding intermediate portion, forming the hook to engage or release the cable from the opposite end of the pole.
